(19) United States
(12) Patent Application Publication
(10) Pub. No.: US 2013/0152767 A1
(43) Pub. Date: Jun. 20, 2013

(54) GENERATING PITCHED MUSICAL EVENTS CORRESPONDING TO MUSICAL CONTENT

(71) Applicants: Itamar Katz, Ramat Gan (IL); Yoram Avidan, Pardes Hana (IL); Sharon Carmel, Ramat Hasharon (IL)

(72) Inventors: Itamar Katz, Ramat Gan (IL); Yoram Avidan, Pardes Hana (IL); Sharon Carmel, Ramat Hasharon (IL)

(73) Assignee: JAMRT LTD, Tel-Aviv (IL)

(21) Appl. No.: 13/642,616

(22) PCT Filed: Apr. 14, 2011
(86) PCT No.: PCT/IL11/00307

§ 371 Date: Mar. 5, 2013

Related U.S. Application Data
(60) Provisional application No. 61/326,785, filed on Apr. 22, 2010.

(51) Int. Cl. G10H 7/00

(52) U.S. Cl. CPC G10H 7/00
USPC 84/616

(57) ABSTRACT

A method of suggesting pitched musical events corresponding to provided digital musical content, comprising obtaining a frequency domain representation of the digital musical content, applying a pitch salience estimation over the frequency domain representation to provide a pitch salience time-frequency map; and grouping local frequency peaks along a time axis of the pitch salience time-frequency map which are substantially continuous in terms frequency and/or salience giving rise to a partial.

### FIELD OF THE INVENTION

The present invention is in the field of processing musical content.

### BACKGROUND OF THE INVENTION

US Patent Publication No. 2009/0165632 to Rigopulos et al. discloses, systems and methods for creating a music-based video game, a portable music and video device housing a memory for storing executable instructions and a processor for executing the instructions. Further disclosed is a process of creating video game content using musical content supplied from a source other than the game which includes: analyzing musical content to identify at least one musical event extant in the musical content; determining a salient musical property associated with the at least one identified event; and creating a video game event synchronized to the at least one identified musical event and reflective of the determined salient musical property associated with the at least one identified event.

### SUMMARY OF THE INVENTION

Some embodiments of the present invention relate to a method and a system for generating pitched musical events corresponding to musical content. According to an aspect of the invention there is provided a method of suggesting pitched musical events corresponding to digital musical content. The method may include: obtaining a frequency domain representation of the digital musical content; applying a pitch salience estimation over the frequency domain representation to provide a pitch salience time-frequency map; and grouping local frequency peaks along a time axis of the pitch salience time-frequency map which are substantially continuous in terms frequency and/or salience giving rise to a partial.

According to a further aspect of the invention, there is provided a system for generating pitched musical events corresponding to musical content. According to some embodiments, the system may include a time-frequency transformation module, a pitch salience estimator and a partial tracker. The time-frequency transformation module may be adapted to provide a frequency domain representation of the musical content. The pitch salience estimator may be adapted to apply a pitch salience estimation over the frequency domain representation to provide a pitch salience time-frequency map. The partial tracker may be adapted to group local frequency peaks along a time axis of the pitch salience time-frequency map which are substantially continuous in terms frequency and/or salience giving rise to a partial.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram illustration of a system for suggesting pitched musical events corresponding to musical content, according to some embodiments of the present invention;

FIG. 2 is a flowchart illustration of a method of suggesting pitched musical events corresponding to musical content, according to some embodiments of the present invention;

FIG. 3A is a waveform illustration of raw PCM data which constitutes a musical content input, in this case, the first few seconds of the song “What I Am” by Eddie Brickel;

FIG. 3B is a spectrogram illustration received as a result of applying STFT to the musical content input of FIG. 3A;

FIG. 3C is a time-frequency map resulting from applying a pitch salience estimation to each time-frame within the spectrogram of FIG. 3B;

FIG. 3D is a map of all local maxima points drawn on top of the pitch salience map;

FIG. 3E is a graphical illustration of partials drawn on top of the pitch salience map and tracked in accordance with some embodiments of the present invention;

FIG. 3F is a graphical illustration of pitched musical events suggested in according with some embodiments of the present invention;

FIG. 4A is a graphical illustration of a single STFT frame shown as amplitude on a logarithmic scale as a function of frequency (solid line) range of interest, and the triangular weights used to calculate the Mel-frequency energy;

FIG. 4B is a graphical illustration of the spectrum from FIG. 4A after whitening was applied;

FIG. 4C is a graphical illustration of the whitened spectrum of FIG. 4B with peaks corresponding to a fundamental frequency of 441 Hz and its first 5 integral multiples shown on top, and the windows around each integral multiple within which the peaks are looked for;

FIG. 4D is a graphical illustration of the whitened spectrum of FIG. 4B with peaks corresponding to a fundamental frequency of 473 Hz and its first 5 integral multiples shown on top, and windows around the multiple integers of the fundamental frequency; and

FIG. 5 is an illustration of a partial tracking process applied over an output of the pitch salience estimator, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “mapping”, “assigning”, “allocating”, “designating”, “recording”, “updating”, “estimating” or the like, refer to the action and/or processes of a computer that manipulate and/or transform data into other data, said data represented as physical, e.g. such as electronic, quantities stored within non-transitive medium. The term “computer” should be expansively construed to cover any kind of electronic device with non-transitive data recordation and data processing capabilities, including, by way of non-limiting example, personal computers, servers, computing system, communication devices, processors (e.g. digital signal processor (DSP), microcontrollers, field programmable gate array (FPGA), application specific integrated circuit (ASIC, etc.) and other electronic computing devices.

The operations in accordance with the teachings herein may be performed by a computer specially constructed for the desired purposes or by a general purpose computer specially configured for the desired purpose by a computer program non-transitively stored in a computer readable storage medium.

In addition, embodiments of the present invention are not described with reference to any particular programming language. It will be appreciated that a variety of programming languages may be used to implement the teachings of the invention as described herein.

Throughout the description of the present invention, reference is made to the term “musical content” or the like. Unless specifically stated otherwise the term “musical content” shall be used to describe any digital representation of acoustical data (sound waves) which may be used for sound reproduction. The digital representation may be the result of the recording of acoustical data and converting it to the digital domain, or may be synthesized in the digital domain, or may be a mixture of digitally synthesized and analog sound converted to the digital domain. The musical content may be a discreet data component or it may be extracted from a multimedia piece. The musical content may be stored on any means of storing digital data (e.g., as a file) or may be embodied in a data stream. The musical content may reside locally or may be obtained from a remote source over a communication network, such as from a remote file server.

Throughout the description of the present invention, reference is made to the term “music based video game”. The term “music-based video game” and similar terms refer to a game in which a dominant gameplay scheme is associated with and/or oriented around musical event(s), or a property of a musical event(s) and the musical events are derived from a certain musical content piece. The gameplay scheme provides a specification for a series of player's interactions which generally correspond to the underlying musical content. One example of a music-based video game is “Rock-Band”, developed by Harmonix Music Systems and published by MTV Games and Electronic Arts in which one of the dominant gameplay schemes involves reproducing, using a dedicated controller that is typically supplied with the game, a simplified musical score containing pitch and timing of notes from popular songs. Another example of a music-based video game is “Tap Tap Revenge”, developed by “Tapulous”, in which the player attempts to tap designated areas of the touchscreen and in a specific sequence and thus reproduces a simplified musical score. In contrast, in certain video games musical content is used for the games' soundtrack, but does not constitute a dominant gameplay scheme. One example of such a game is Grand Theft Auto (GTA) San Andreas, where while the player's game character is driving a car, the player can change the game's soundtrack by changing a station in the car's radio. Other than changing the soundtrack of the game, the player's selection of the radio station does not influence the game's dominant gameplay scheme and is not, therefore, “music-based” in the sense used herein.

Other features of music based video games may also be influenced by the underlying musical content. For example, a visual component of the gameplay scheme may be influenced by a musical event(s) or properties of a musical event(s) derived from the musical content.

Throughout the description of the present invention, reference is made to the term “musical content”. The term “musical content” as herein relates to any digital audio data in any format and includes digital data audio that is embedded or otherwise included as part of any digital multimedia content and in any format. Methods and techniques are known in art for extracting audio content from various digital multimedia content formants and may be used as part of some embodiments of the present invention.

Throughout the description of the present invention, reference is made to the term “pitched musical instrument”. The term “pitched musical instrument” is known in the art and the following definition is provided for convenience purposes. Accordingly, unless stated otherwise, the definition below shall not be binding and this term should be construed in accordance with its usual and acceptable meaning in the art. “Pitched musical instrument” relates to any musical instrument which is capable of producing sound to which a psychoacoustic sensation of a fundamental frequency can be attributed, at least to some extent. A pitched musical instrument may be acoustical, electrical, mechanical, software-implemented (“virtual”), or any combination of the above. The attributed sensation of a fundamental frequency may vary, ranging from easily discerned fundamental frequency, to one which is relatively difficult to discern, depending mostly on the spectral content of the produced sound.

Typically, in musical based video games the gameplay is generated with some correlation to the musical content. In order to extract a gameplay scheme from a given musical piece certain musical events within the musical piece are identified and certain gameplay events which correspond to the musical events are generated. The gameplay features are substantially time synchronized with corresponding musical events and are generally related to one or more properties of the musical events. In some cases, the correlation between the gameplay features and the corresponding musical events convey a sensation to the player which is related to reproducing the musical content or some portion or component thereof. For example, a user playing the role of a guitar player in Harmonix's Rock Band game is presented with certain gameplay features which are intended to convey to the player a sensation of playing the role of a guitarist within a selected musical piece. It would be appreciated, that the actual guitar part within the original musical piece may be different in various respects compared to the gameplay features used to convey the sensation of playing the guitar part. The same applies to any other musical part and to the corresponding gameplay features which are generated to convey to the player sensation of playing a role within the selected musical piece that is related to the respective musical part. Some examples of musical parts may include, but are not limited to: drums, lead singer, bass guitar, one or more mixed tracks of the musical piece, keyboard, percussion, and combinations thereof.

As mentioned above, in order to extract a gameplay scheme from a given musical piece certain musical events within the musical piece are identified and certain gameplay events which correspond to the musical events are generated. As used herein, the term “musical event”, or “musical events” in the plural from, includes rhythmic accents on various timescales (such as beats or bars), notes, where a note is defined as an acoustic event occurring within a well-defined time window, and which is the result of playing a distinct musical sound on a musical instrument (as defined below), including sounds with a changing envelope of pitch, loudness, or timbre, percussive events (such as snare drum, tom-tom, or bass drum “hits”), transition in musical structure (such as the transition from chorus to verse), recurrence of a musical patterns (for example, a riff), tempo and tempo changes. Each musical event includes temporal data to enable synchronization of gameplay features with overlying musical events. For example, each musical event may include a start time and a duration parameter.

As mentioned above, the gameplay features are generally related to one or more properties of the musical events. Properties of the musical events include, but are not limited to, the pitch of the musical event, loudness of the musical event, timbre of the musical event (sometimes referred to as “tone color” or “tone quality”), spectral distribution of the musical event, and an envelope of any of the above properties. For example, the pitch of a musical event is generally associated with the fundamental frequency F₀. The property of fundamental frequency can be translated to a specific button located at a specific position on the controller, such that a certain pitch relation between two musical events is translated to a certain positional relation between two buttons. Another example is when the loudness envelope of a musical event is identified to have a very short rise and fall times, i.e. it has percussive nature. Such a musical event can be used to create a gameplay event attributed to a “drums” part.

In many cases, the correlation between the musical content piece and the gameplay is based on human judgment. A (human) content creator determines and/or configures gameplay events according to the underlying musical content piece. Possibly, the content creator has access and is able use individual audio tracks which are mixed in the musical content piece. It would be appreciated that being able to selectively use a certain track(s) is helpful in the process of generating gameplay features which are intended to convey to a player a sensation of playing a specific role within a selected musical piece.

As mentioned above, it has been suggested in US Patent Publication No. 2009/0165632 to Rigopulos et al. to create video game content using musical content supplied from a source other than the game by: analyzing musical content to identify at least one musical event extant in the musical content; determining a salient musical property associated with the at least one identified event; and creating a video game event synchronized to the at least one identified musical event and reflective of the determined salient musical property associated with the at least one identified event.

Certain aspects of the present invention relate to systems and methods of suggesting pitched musical events corresponding to musical content. Although some embodiments of the present invention are not limited in this respect, the herein proposed invention may be used as a basis for generating a gameplay scheme for a music-based video-game, or at least some portion of the gameplay scheme. According to further embodiments of the present invention, the pitched musical data output may be combined with data in respect of other musical events and the gameplay scheme may be generated based on the combined data. The generation of such other musical events is beyond the cope of the present invention.

A method of suggesting pitched musical events corresponding to musical content according to some embodiments of the present invention may include: obtaining a frequency domain representation of the musical content; applying a pitch salience estimation to the frequency domain representation to provide a pitch salience time-frequency map; and grouping of local frequency peaks along the time axis of the pitch salience time-frequency map which are substantially continuous in terms frequency and/or salience giving rise to a partial. Further details with respect to some embodiments of the invention shall now be described.

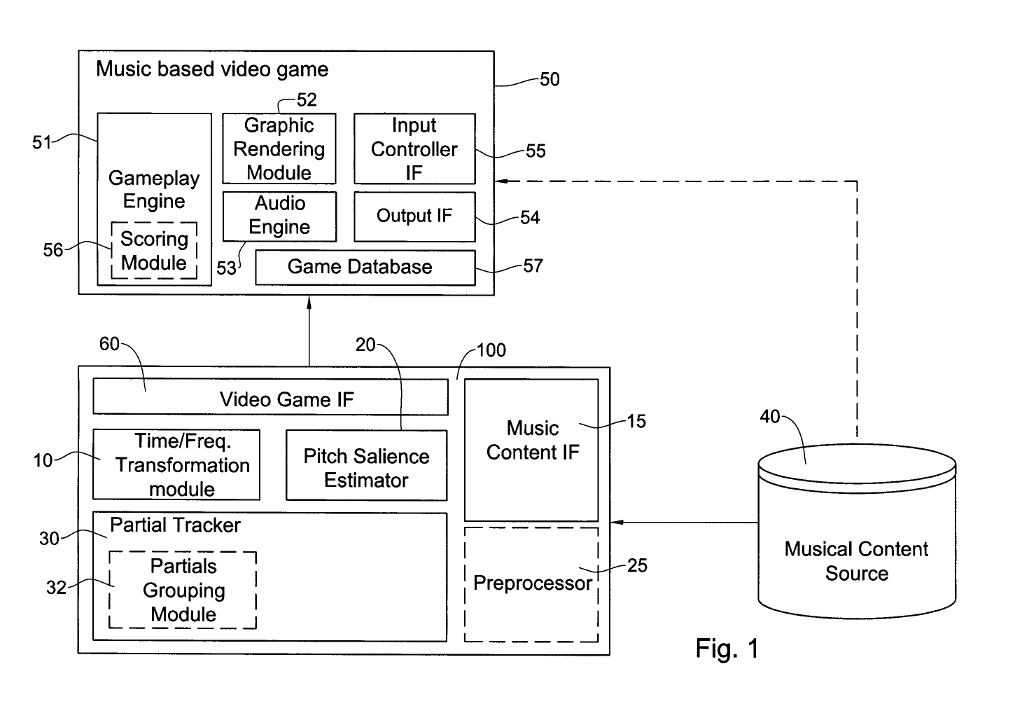

Reference is now made to FIG. 1, which is a block diagram illustration of a system for suggesting pitched musical events corresponding to musical content, according to some embodiments of the present invention. According to some embodiments of the invention, there is provided a system 100 which is responsive to receiving musical content for generating pitched musical events corresponding to the musical content. The system for suggesting pitched musical events 100 may include a time-frequency transformation module 10, a pitch salience estimator 20 and a partial tracker 30, the operation of which is described below.

According to some embodiments, the system 100 may be operatively connected to a musical content source 40. The musical content source 40 may be any type of digital audio and/or multimedia data repository, including but not limited to, a local disk, a remote file server, and any type of connection may be used to connect the system 100 and the musical content source 40, including but not limited to, LAN or WAN. As mentioned above, the term musical content as used herein may include one or more of the following: a music file of any known audio file format such as WAV, MP3, AIFF; an audio component of a video file of any known video format such as MP4, DVD, QuickTime; an audio stream received through a network from an internet radio station; and an audio component of a video steam received through a network from a remote website.

Possibly, the system 100 may include a music content interface 15 which may be configured to establish a connection with the musical content source 40 and to provide raw pulse-code modulation (“PCM”) data (or similar audio signal representation) to the modules of the system 100. For example, in case the format of the musical content retrieved from the musical content source is an encoded and compressed MPEG-1 Audio Layer 3 (“MP3”) file, the music content interface 15 may be utilized to decode the MP3 file and the raw PCM is then used as the musical content which is processed by the system 100 for suggesting pitched musical events. In another example, the data obtained from the musical content source 40 is a multimedia file, for example an MPEG-4 file or an MPEG-4 part 10 file, and the music content interface 15 is used for extracting the digital audio content from the multimedia file, and if necessary, is further used to generate the raw PCM representation of the audio signal.

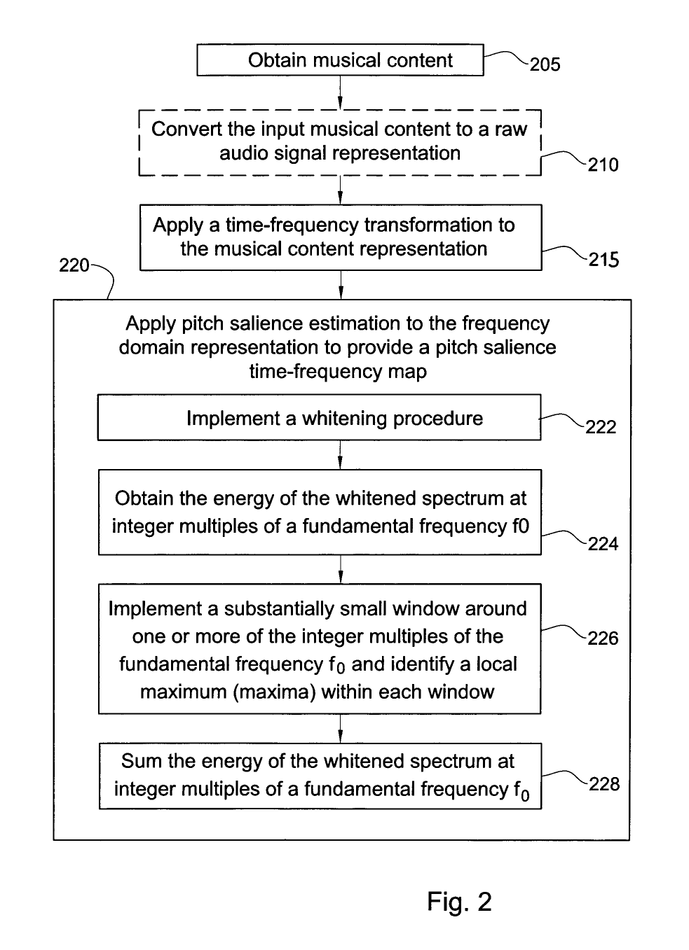

Reference is now additional made to FIG. 2, which is a flowchart illustration of a method of suggesting pitched musical events corresponding to musical content, according to some embodiments of the present invention. Once the musical data is obtained (block 205), and possibly after being converted to a raw audio signal representation (block 210), the musical data is fed to the time-frequency transformation module 10, where it undergoes a time-frequency transformation (block 215). The output of the time-frequency transformation module 10 is a representation of an instantaneous frequency component(s) of the signal, and this representation may be provided over one or more time frames.

According to some embodiments, the time-frequency transformation module 10 may be configured so that the output of the transformation represents a specific tiling scheme of the time frequency plane. For example, and in accordance with further embodiments of the invention, the time-frequency transformation module 10 may be configured to perform Short-Time Fourier Transform (“STFT”), with specific frame length and windowing function. According to still further embodiments, the frame length is selected taking into account the polyphonic nature of the input musical content, and in particular the assumption that different audio sources may have overlapping distribution in the frequency domain. Accordingly, the selected frame duration is relatively large, for example, in the order of 50-200 milliseconds, so that a frequency resolution of approximately 5 Hz-20 Hz is attained.

Continuing with the description of FIG. 2, the output of the time-frequency transformation module 10, namely the time-frequency map, is fed to the to the pitch salience estimator 20, where pitch salience estimation is applied to the time-frequency representation of the input musical content to provide a pitch salience time-frequency map (block 220).

Typically, in a given STFT frame (and possibly in other time-frequency representations) a pitched musical event is associated with a plurality of substantially equally spaced (as measured in Hz) local maxima points (or local peaks). Additionally, under some circumstances, an overall trend may exist in the time-frequency representation which may result in an attenuation of the local average energy as frequency increases. Such circumstances may include or may be associated with, for example, the physical properties of a pitched musical instrument, or the specific choice of sound design in the case of an artificial or synthesized (e.g., computer based) pitched sound source. Under other circumstances, a local trend may exist in the time-frequency representation which may result in the attenuation or increase of the energy of a specific frequency band.

Other time-frequency transformations which may be applied by the time-frequency transformation module 10 may include Wavelet transform, any distribution function which belongs to Cohen's class distribution function, or fractional Fourier transform. The same design considerations and post-processing considerations which were described above may apply as well to other time-frequency transformations.

Due to the attributes of the time-frequency representation, and in particular due to the attributes of the STFT representation, identifying a frequency-signature within the frame which may imply pitched content within the frame involves identifying groups of related frequency peaks which are (potentially) associated with a common (single) pitched musical event. For example, a frequency-signature of a pitched musical event within a frame may include peaks in the fundamental frequency of the respective pitch but may also show peaks approximately at the integer multiples of that pitch's fundamental frequency. Pitched salience estimation over a given frame of STFT provides an estimation of the energy in a single pitch as opposed to energy in a single frequency.

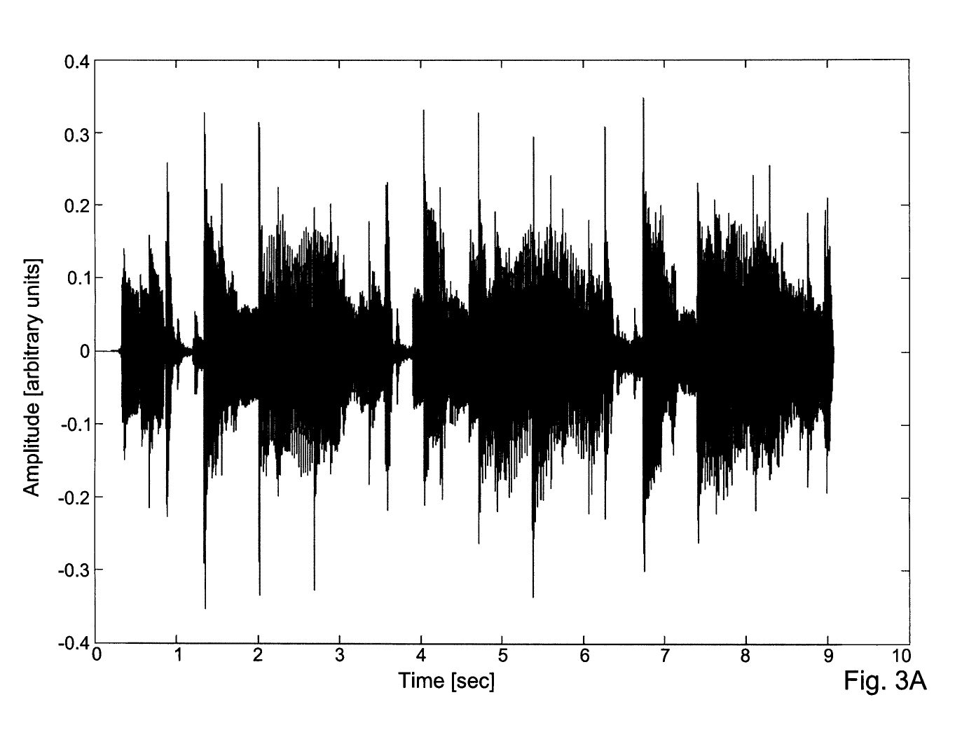

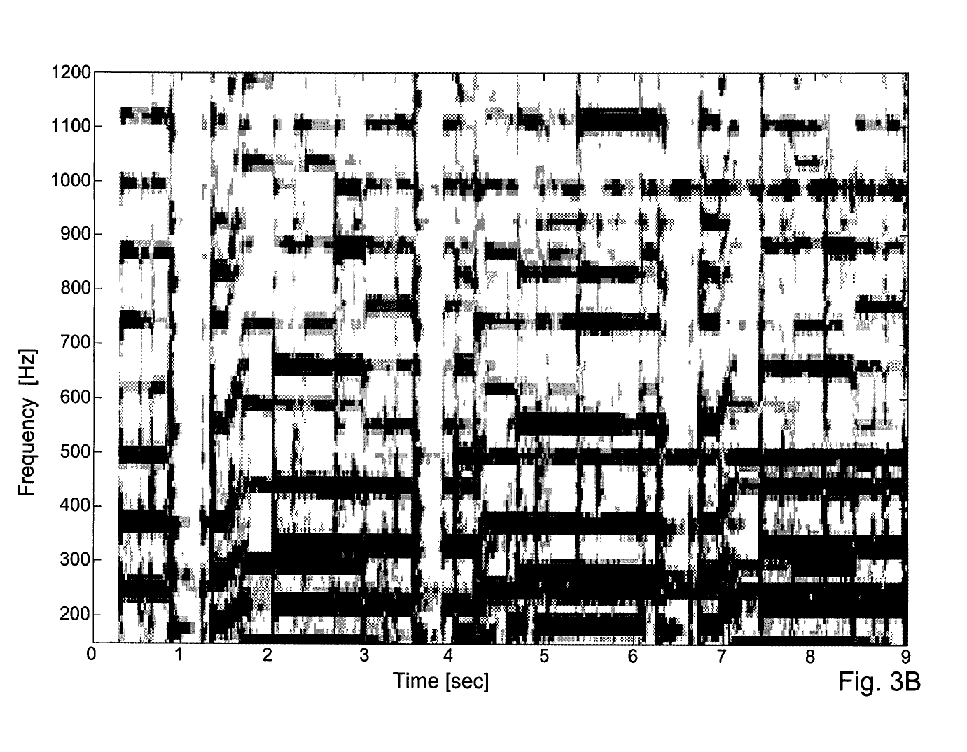

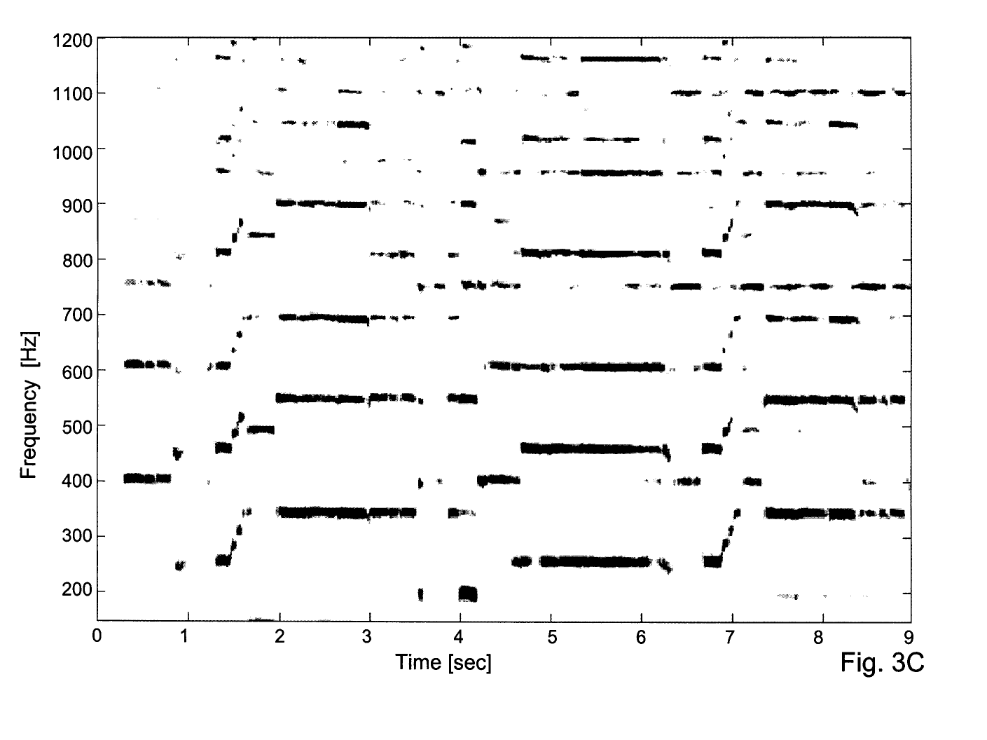

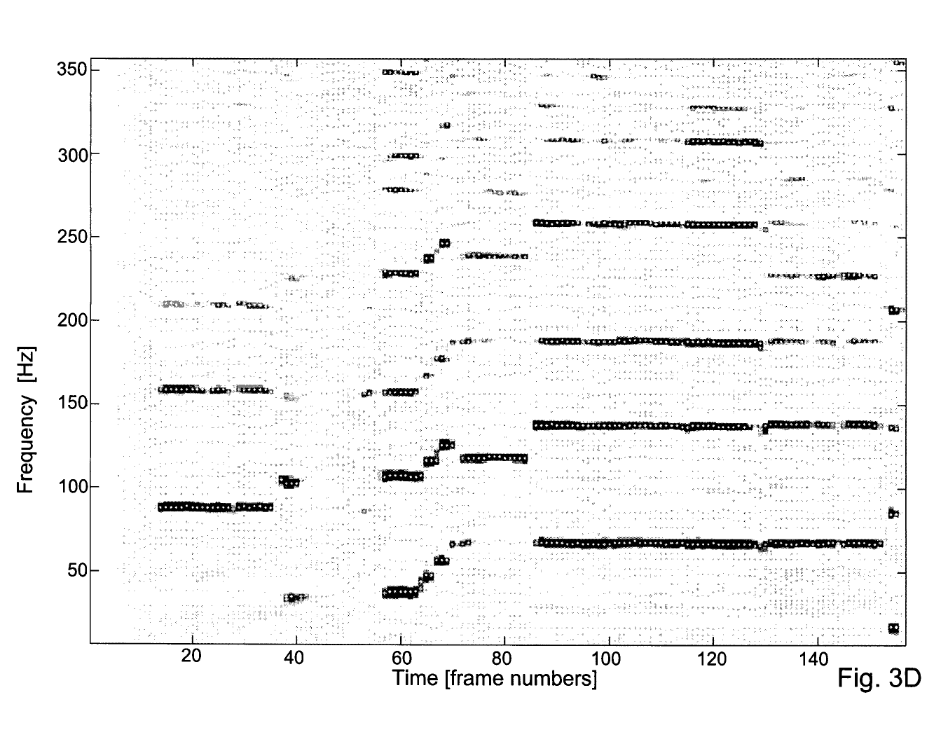

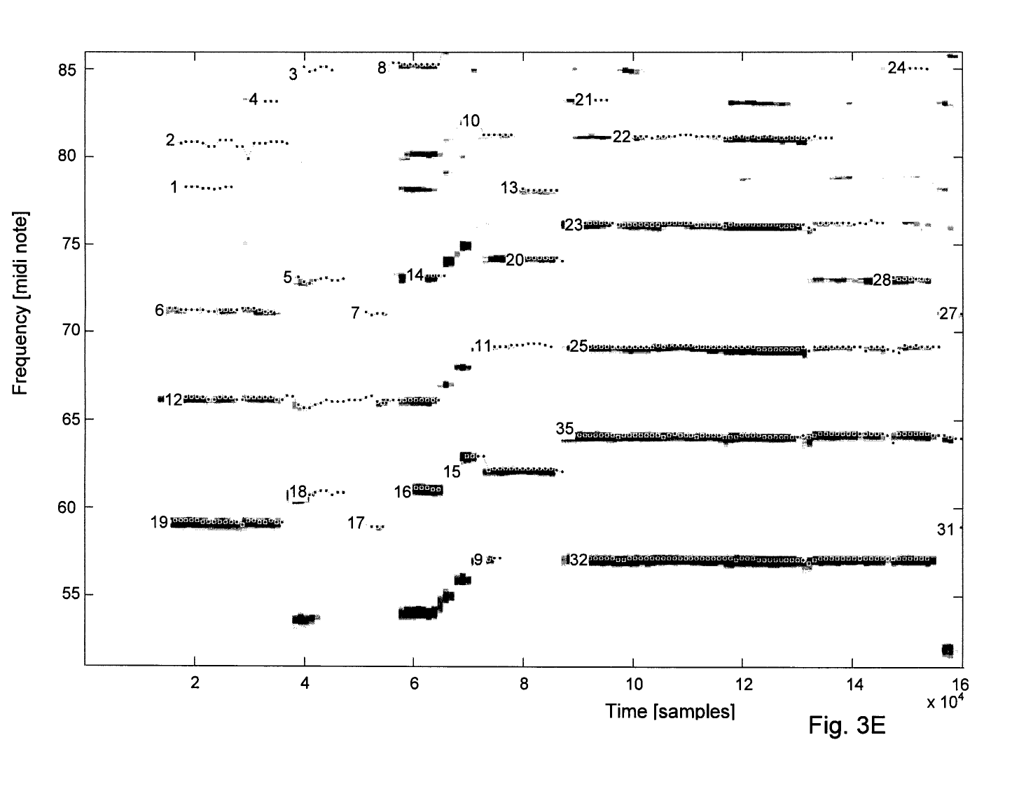

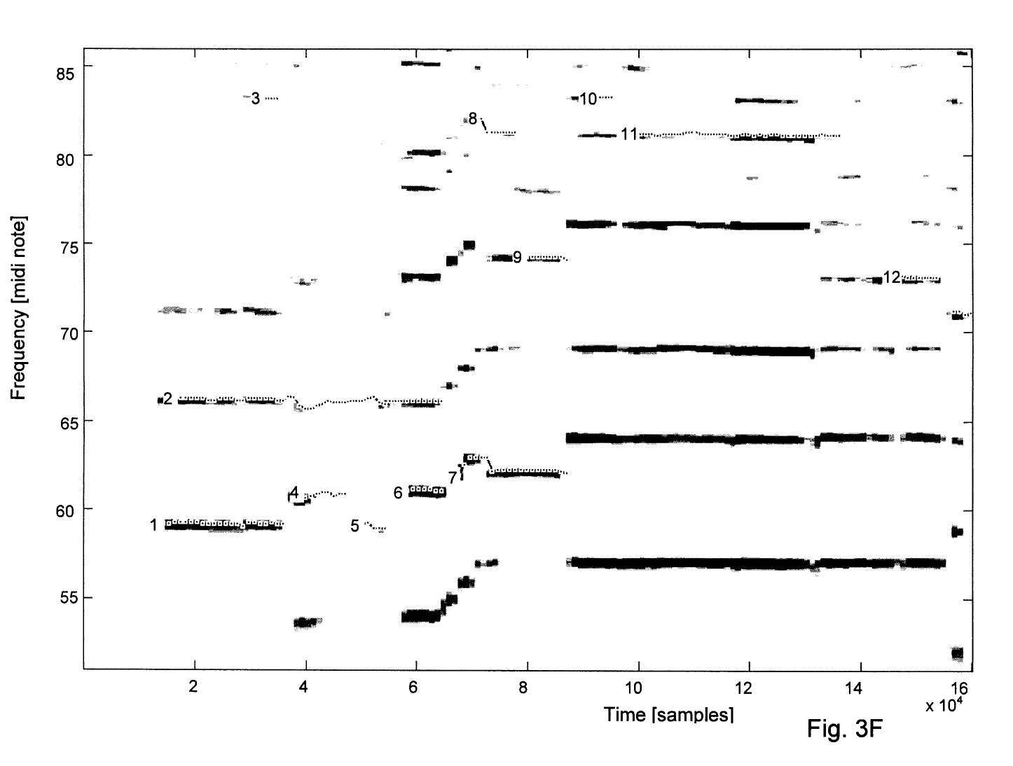

FIG. 3A is a waveform illustration of a raw PCM data which constitutes a musical content input, in this case, the first few seconds of the song “What I Am” by Eddie Brickel. FIG. 3B is a spectrogram illustration received as a result of applying STFT to the musical content input of FIG. 3A. FIG. 3C is a time-frequency map resulting from applying a pitch salience estimation to each time-frame within the spectrogram of FIG. 3B. As can be seen in FIGS. 3B and 3C, there is a substantial difference between the representation of the musical content input following the pitch salience estimation compared to STFT spectrogram. FIG. 3D is a map of all local maxima points drawn on top of the pitch salience map. FIG. 3E is a graphical illustration of the partials found by the partial tracker 30 drawn on top of the pitch salience map.

FIG. 3F is a graphical illustration of the pitched musical events found by the partials grouping module 32.

As mentioned above, within a STFT frame, under certain circumstances, an overall or a local trend may exist which may result in an attenuation or increase of the local average energy at different frequencies. According to some embodiments, the pitch salience estimator 20 may implement a “whitening” procedure (block 222) to remove, at least to some extent, the effects of the overall or local trend before summing different frequency peaks associated with a single pitch. The whitening procedure provides certain frequency peaks, which are otherwise attenuated or increased by the overall or local trend, to receive approximately equal weight. A whitening procedure may involve, for example, transforming the STFT energy within a given frame into a Mel scale (or any other psychoacoustic frequency scale) representation, followed by a bin-wise division of the original STFT frame by the Mel-scale energy interpolated to the frequency resolution of the STFT frame. In a further embodiment, partial whitening may be achieved by raising the whitening coefficients to a power between zero and one before the bin-wise division, zero corresponding to no whitening at all and one corresponding to full whitening.

The pitch salience estimator 20 is adapted to estimate the salience of at least one fundamental frequency f₀ by summing the energy of the whitened spectrum at integer multiples of the fundamental frequency f₀ (block 228). According to some embodiments, the estimation at block 228 is limited to a certain number of integer multiples of the fundamental frequency f₀. In further embodiments, the estimation is limited to approximately the smallest 5-20 integer multiples of the fundamental frequency f₀ (including f₀ itself).

According to still further embodiments, a substantially small window around one or more of the integer multiples of the fundamental frequency f₀ is used and a local maximum (maxima) within each window is identified (block 226). In some embodiments, the estimation at block 228 may use the local maxima value within the window from block 226, rather than the value at the exact multiple of the fundamental frequency.

In still further embodiments, pitch salience estimator 20 is adapted to assign weights to the energy values of one or more of the whitened spectrum integer multiples of the fundamental frequency f₀ (block 224). As mentioned above, within a given frame an overall trend may cause the local average energy to be attenuated with increasing frequency. In some cases, due to this overall trend, the energy level at the higher frequencies' peaks may approach the level of the background noise, and the reliability of the information that can be extracted from such higher frequencies' peaks may be compromised. Accordingly, the pitch salience estimator 20 may generally assign lower weights to the higher frequencies' peaks.

There is now provided a non-limiting example of one possible configuration of a pitch salience estimation process that may be used, also by way of example, to estimate pitch salience when applied to a STFT frame. In this example, the frequency range of interest spans the 3 octaves in the range 150 Hz-1200 Hz, that frequency range is sampled on a logarithmic scale with a resolution of 0.1 semitones, the number of Mel-scale frequency bands used for calculating the whitening coefficients is 60, and the power to which the whitening coefficients are raised is 0.9 (almost full whitening).

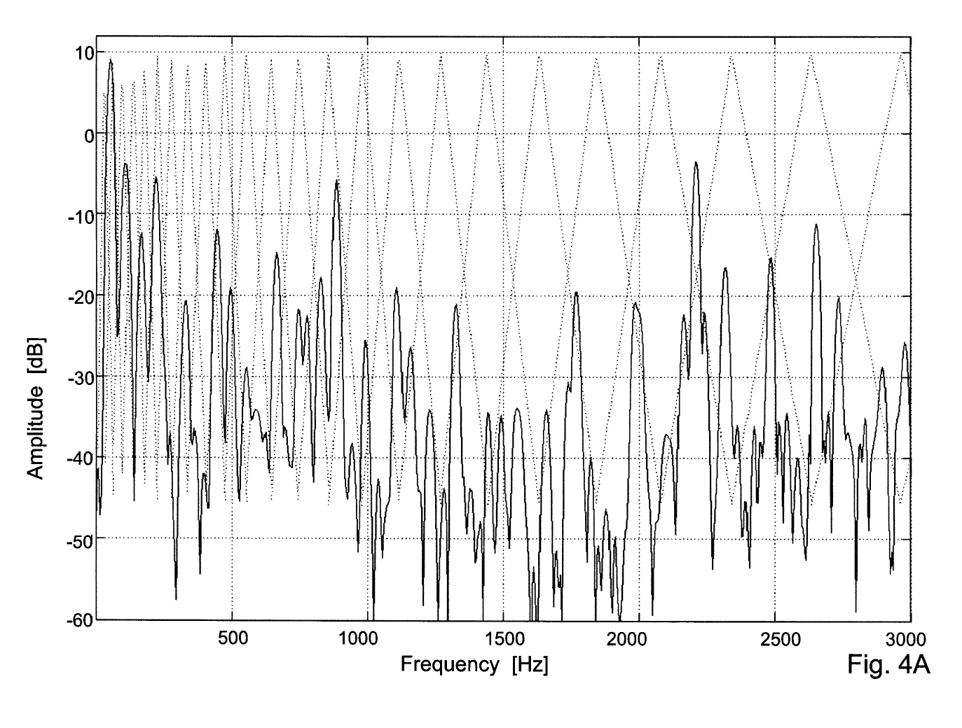

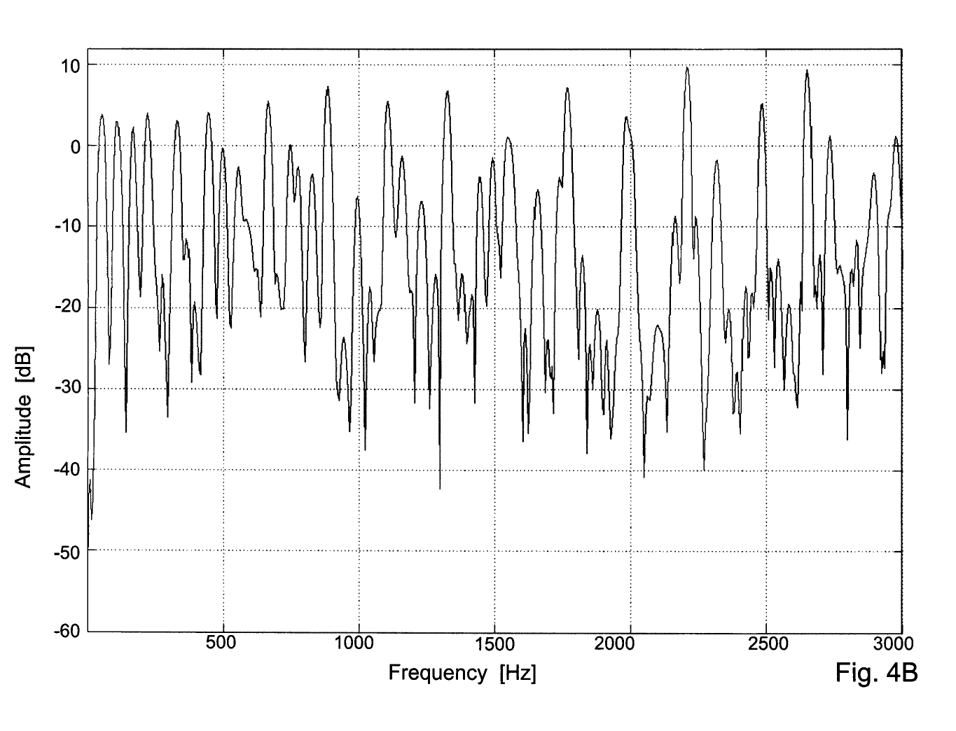

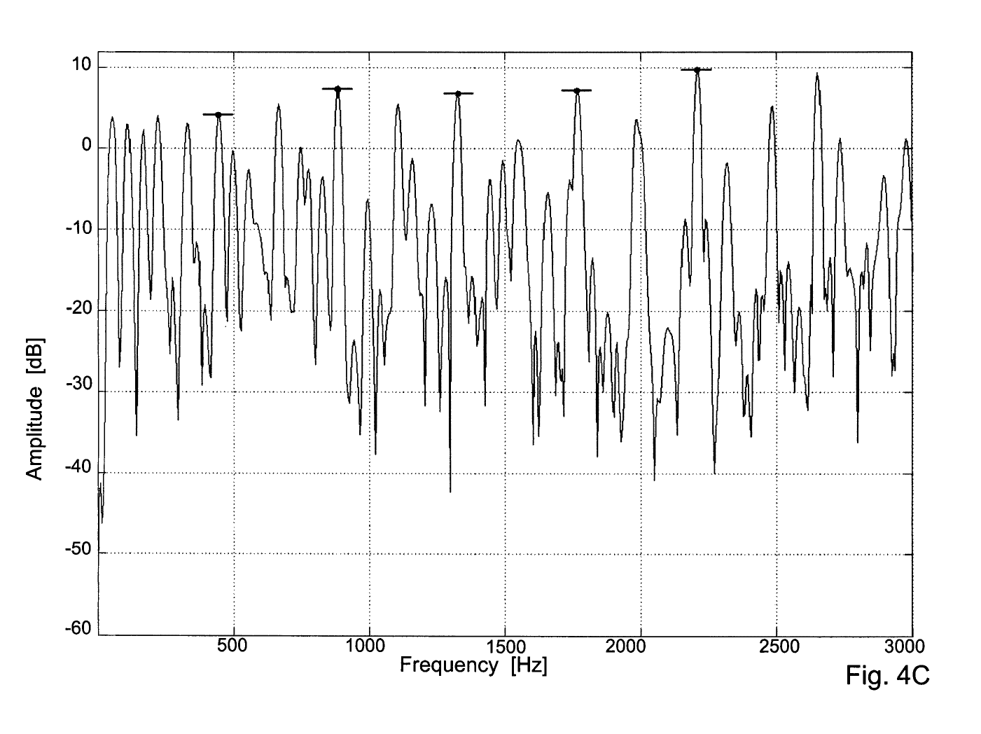

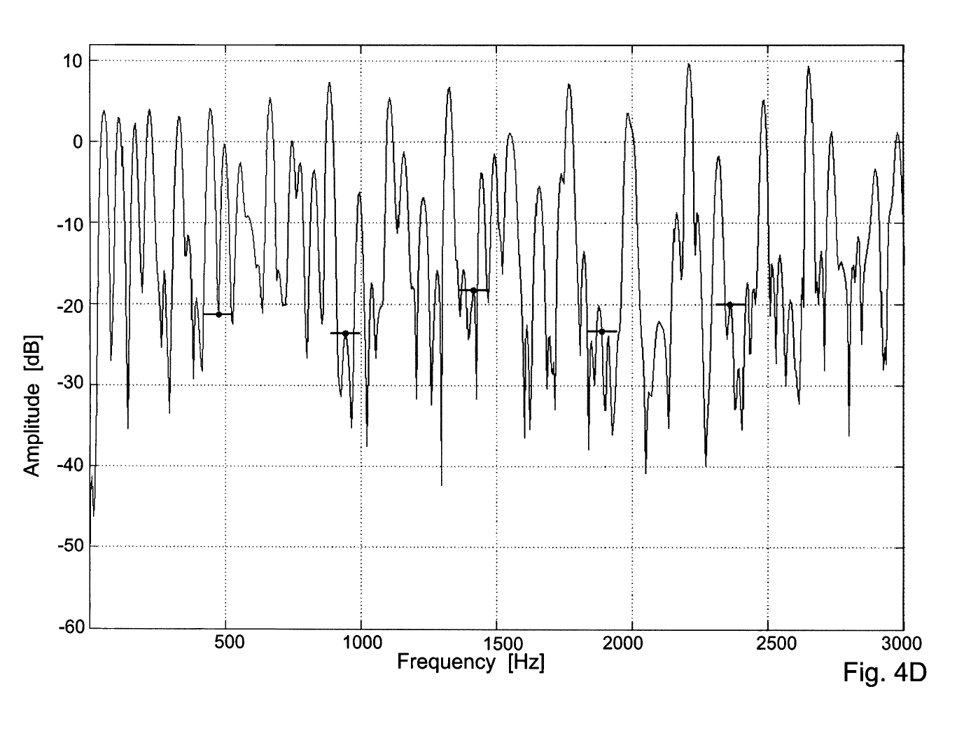

FIGS. 4A-4D are provided by way of example as a graphical illustration of some of the stages of a pitch salience estimation process implemented as part of some embodiments of the present invention. FIG. 4A is a single STFT frame shown as amplitude on a logarithmic scale as a function of frequency (solid line). Only a frequency range of interest is shown. On top of the spectrum, the triangular weights used to calculate the Mel-frequency energy are shown (dotted line). The y axis scale for the Mel-scale weights is different, to allow showing it on top of the spectrum. Only every second triangle is shown for better visibility. FIG. 4B is the spectrum from FIG. 4A after whitening was applied. It is evident that the average local energy at different frequencies is approximately constant, as opposed to FIG. 4A. FIG. 4C is the whitened spectrum of FIG. 4B with peaks corresponding to a fundamental frequency of 441 Hz and its first 5 integral multiples shown on top. Also shown are the windows around each integral multiple within which the peaks are searched for. The width of the window is highly larger than its real value to allow better visibility. It is evident that summing the energy of these peaks would result in a high salience value for a fundamental frequency of 441 Hz. FIG. 4D is the whitened spectrum of FIG. 4B with peaks corresponding to a fundamental frequency of 473 Hz and its first 5 integral multiples shown on top. Windows around the multiple integers of the fundamental frequency are shown as in FIG. 4C. It is evident that summing the energy of these peaks would result in a low salience value for a fundamental frequency of 473 Hz.

The pitch salience estimator 20 is adapted to apply pitch salience estimation process for each of the frames in the STFT representation. Within each frame, the pitch salience estimation process may be applied to each one of a plurality of predefined fundamental frequencies. In some embodiments, the fundamental frequencies may be obtained by linearly sampling a frequency range of interest. In other embodiments, the fundamental frequencies may be obtained by logarithmically sampling a frequency range of interest. In some embodiments, the frequency range of interest may be associated with known acoustical properties of common musical instruments. By way of non-limiting example, the frequency range of interest may be in the order of 250 Hz-1100 Hz.

The frequency resolution that is provided by the pitch salience estimator 20 for estimating pitch salience is associated with the characteristics of the sampling points (e.g., the number of sampling points) and with the sampling method (linear or logarithmic) used during the pitch salience estimation. In some embodiments, the frequency resolution is further based on the frequency resolution of the STFT. While a higher frequency resolution is possible when disregarding the frequency resolution of the STFT, it would not necessarily improve the ability to distinguish, based on the pitch salience estimation, between two notes with closely spaced fundamental frequencies, since the frequency resolution of the STFT introduces a limitation in this regard.

According to some embodiments, the output of the pitch salience estimator 20 is a collection consecutive timeframes, and within each frame the pitch salience estimator 20 provides an estimation of pitch salience according to the plurality of predefined fundamental frequencies mentioned above. The output of the pitch salience estimator 20 includes a pitch salience timeframe for each STFT frame generated by the time-frequency transformation module 10.

According to some embodiments, a signature of a pitched musical event may be characterized by a series of high salience values over time where the frequency values present approximate continuity. According to further embodiments, a signature of a pitched musical event may be characterized by a series of local maxima values within a salience-frequency curve whose frequency values present approximate continuity. According to still further embodiments, a signature of a pitched musical event may be characterized by a series of local maxima values within a pitch-salience time-frequency map whose frequency values present approximate continuity and whose salience levels also present approximate continuity. A series of local maxima values which meets the continuity criteria mentioned above is sometimes referred to herein as “a partial”.

The partial tracker 30 is configured to receive the output of the pitch salience estimator 20. The partial tracker 30 is adapted to process the output of the pitch salience estimator 20. The partial tracker 30 is adapted to identify within the pitch salience estimation data a signature of a pitched musical event, and possibly a plurality of such signatures for a respective plurality of pitched musical events.

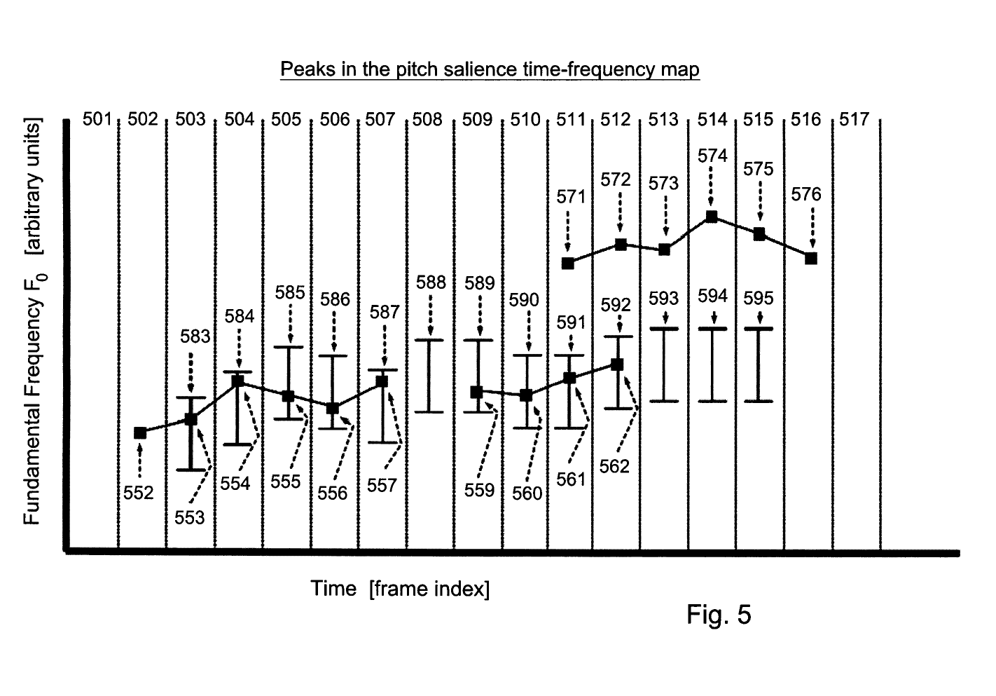

Reference is now made to FIG. 5, which is an illustration of a partial tracking process applied over an output of the pitch salience estimator, according to some embodiments of the present invention. As can be seen in FIG. 5, initially the partial tracker 30 searches an entire frame of the pitch salience estimation data for local maxima points. A local maxima point within a frame of pitch salience data is a local maxima within a salience-frequency curve.

In this case, the process begins at frame 501 and the partial tracker 30 finds that there are no significant maxima points within frame 501. The partial tracker 30 is configured to regard a frame without any significant maxima points, such as frame 501, as irrelevant for identifying a signature of a pitched musical event.

The partial tracker 30 thus proceeds to frame 502. At frame 502, a local maxima 552 is identified by the partial tracker 30. The partial tracker 30 stores data with respect to the local maxima, including for example, the respective frame location, salience level and frequency value of the identified local maxima. The data may be stored in a cache memory or within any other suitable data retention unit or entity that is used by the system 100 for this purpose.

Once the processing of frame 502 is complete (or possibly in parallel), the partial tracker 30 advances to the next frame 503 and searches for local maxima points within frame 503. In case a local maxima point 553 is found within frame 503, the partial tracker 30 is adapted to evaluate the frequency value of the local maxima point 553 against the frequency value of one or more local maxima points identified within previous frames, in order to determine whether there is a predefined relation among the frequency values of the local maxima points 553 and 552. In FIG. 5, the frequency value of the local maxima point 553 may be evaluated against the frequency value of the local maxima point 552.

In some embodiments, the relation among the frequency value of the local maxima point within a current frame and the frequency value(s) of local maxima point(s) identified within previous frame(s) is an approximate continuity of the frequency value across the frames. Such approximate continuity may be determined using known continuity measuring techniques. One possible technique is setting a threshold to the maximal jump allowed in frequency values of local maxima points within consecutive frames. Such a threshold should reflect the nature of the underlying acoustic phenomena. For example, the rate of change in the pitch of a note produced by a guitar player bending a string usually does not exceed 10 Hz, while the amplitude of the pitch change usually does not exceed 3 or 4 semitones. If the rate of analysis windows is known, a maximal jump in the frequency values of local maxima points within consecutive frames can be calculated and used as a threshold. A jump that is larger than the calculated threshold may imply that the second pitch salience peak is not associated with the same pitched musical event as the first peak.

In some embodiments, the search for the local maxima point may be carried out within a frequency window that is generated based on the frequency value(s) of a local maxima point(s) identified within a previous frame(s). For example, the frequency window may be a straightforward margin around the frequency value of a local maxima within a previous frame, however it may also be otherwise determined, including, by way of example, based on a prediction function taking into account a plurality of local maxima frequency values associated with a plurality of preceding frames. In this implementation, the required relation among the frequency value of a local maxima point within a current timeframe and the frequency value(s) of local maxima point(s) within previous timeframes) is denoted by the window. Generally, the window enables a tolerance with respect to the estimated continuity of the frequency at the local maxima point. Windows 583-595 for a series of local maxima points 552-557 and 559-562 are shown in FIG. 5. Since a window is generated based on the frequency value(s) of a local maxima point(s) identified within a previous frame(s), there isn't a window within frame 502. Windows 588 and 593-595 are discussed below.

In FIG. 5, the frequency value of local maxima point 553 is within a frequency window 583 derived from the frequency value of local maxima point 552, and so the two points 552 and 553 are identified by the partial tracker 30 as being associated with what is possibly a common pitched musical event. The association of each of the two points 552 and 553 with what is possibly a common pitched musical event is recorded.

In some embodiments, in addition to searching for a certain relation among frequency values of local maxima points within consecutive frames, the partial tracker 30 may be adapted to search for a certain relation among salience values of local maxima points within consecutive frames. In some embodiments, the relation among the salience value of the local maxima point within a current frame and the salience value(s) of local maxima point(s) identified within previous frame(s) is an approximate continuity of the salience value across the frames. Such approximate continuity may be determined using known continuity measuring techniques. One possible technique is to set a threshold for the maximal allowed jump in pitch salience values of local maxima points across consecutive frames. For example, such a threshold may be determined empirically by observing typical jumps in pitch salience values between consecutive frames in which a pitched musical event begins or ends. In the example of FIG. 5 the frequency values at local maxima 552 and 553 are substantially continuous. In the example of FIG. 5 the salience levels at local maxima points 552 and 553 are substantially continuous. In some embodiments, a tolerance measure, for example, similar to the window based on frequency value(s) of a local maxima point(s) within a previous frame(s), may be used with respect to the estimated continuity of the salience level at a local maxima point, and may be based on the salience level(s) of a local maxima point(s) within a previous frame(s).

The partial tracker 30 may process frames 504-507 in a similar manner to the processing of frame 503 and may determine that the frequency value and the salience level at local maxima points 554-557 within respective frames 504-507 present the predefined continuity relation.

At some point, and in the example shown in FIG. 5 at frame 508, the relation between a local maxima point 558 and one or more local maxima points 552-557 within one or more respective previous frames 502-507 no longer meets the predefined relation. This is shown in FIG. 5 by the empty window 588, indicating that no local maxima point which meets the continuity criteria implemented through the window 588 is found within frame 508. In some embodiments, the relation is defined by a prediction that is based on one or more local maxima points 552-557 within one or more respective previous frames 502-507. In still further embodiments, the predefined relation is associated with continuity across one or more frames in terms of frequency at local maxima points within the frames. In yet further embodiments, the predefined relation is further associated with continuity across frames in terms of a salience level at local maxima points within the frames. Examples of criteria which may be used for evaluating continuity were provided above.

As mentioned above, the partial tracker 30 may be configured to detect a signature of a pitched musical event, and the signature may be characterized by a series of local maxima points (within a respective series of frames) with high salience values which are approximately continuous in frequency value. Possibly, the series of local maxima points which characterize the pitched musical event signature may also be required to show approximate continuity in terms of the salience level across the frames. In some embodiments the partial tracker 30 may allow a transient discontinuity in terms of the frequency value and possibly also a transient discontinuity in terms of the salience level value. In still further embodiments, the partial tracker 30 may be configured to ignore transient discontinuity, when the duration of the discontinuity is less than a predefined duration (e.g., across a certain number of frames), and may continue a series of local maxima points with continuity in terms of frequency value (and possibly also salience level) even when the series is interrupted by such a short term transient discontinuity.

For example, in FIG. 5, the partial tracker 30 may be configured to allow a transient discontinuity in terms of the frequency value or in terms of the salience level, when the duration of the discontinuity is less than three frames. Accordingly, the partial tracker 30 may continue a series of local maxima points which present continuity in terms of frequency value and in terms of salience level even when the series is interrupted for a duration of up to two frames. Thus, by way of example, the continuity presented by the local maxima points 552-557 within frames 502-507 is broken at frame 508, but the series is resumed at frame 509 with local maxima point 559, and so frame 508 is skipped and the local maxima points 559-562 are added to the series. In some embodiments, the duration that is missing from the series, namely the duration which corresponds to frame 508, may be extrapolated based on one or more local maxima points from the series. In further embodiments, the missing duration is ignored.

According to some embodiments, the partial tracker 30 may be configured to identify an end of a series (or an end of a partial) when the frequency value or possibly when a salience level at local maxima points within a certain number of consecutive frames is discontinuous with the respective values or levels of a series of local maxima points within previous frames. In further embodiments, the partial tracker 30 is configured to end the series after identifying a predefined number of frames wherein the frequency value or possibly the salience level at local maxima points is not continuous with the respective values or levels of a series of local maxima points within previous frames. The series ends with the last local maxima point which presented continuity in terms of frequency value and possibly also in terms of salience level with the previous local maxima point in the series and the discontinuous local maxima points after than are discarded from the series.

Thus, for example, in FIG. 5, the partial tracker 30 may identify that the frequency value at the local maxima point within frames 513, 514 and 515 is not in continuity with the local maxima points 552-557 and 559-562, and may thus determine that the series of local maxima points ended at frame 512 with local maxima point 562. This is shown in FIG. 5 by the empty windows 593-595, indicating that no local maxima points which meet the continuity criteria implemented were found within frames 513-515.

The partial tracker 30 may be adapted implement a pitched musical event signature identification process. As part of the pitched musical event signature identification process, the partial tracker 30 may be configured to process an identified partial.

According to some embodiments, in case no other partials are identified within the same time span, the pitched musical event signature is the partial itself. The partial tracker 30 may be responsive to identifying the signature of a pitched musical event for extracting from the partial predefined musical properties. According to some embodiments, musical properties extracted from the partial may include, but are not necessarily limited to: start time, duration, pitch envelope, average pitch, salience envelope, average salience, etc. In some embodiments the musical properties extracted from the partial may be provided by the system 100 as output.

In some embodiments, the partial tracker 30 may be configured to identify and track a plurality (two or more) of local maxima points series, each local maxima point series is characterized by approximate continuity in terms of frequency value and possibly also approximate continuity in terms of salience level. This is shown in FIG. 5 by way of example, where in addition to the series of local maxima points 552-557 and 559-562 described above, a second series of local maxima points 571-576 that is characterized by approximate continuity in terms of frequency value and possibly also approximate continuity in terms of salience level is identified. The second series of local maxima points 571-576 are identified within respective frames 511-516, and so the second series of local maxima points 571-576 partially overlaps in time with the first series of local maxima points 552-557 and 559-562, which is associated with frames 502-507 and 509-512. The partial tracker 30 may instantiate a plurality of trackers to track the plurality of overlapping partials.

As mentioned above, in case no other partials are identified within the same time span, the pitched musical event signature is the partial itself. However, in some cases the partial tracker 30 may identify two or more partials which at least partially overlap in time. In such cases, the partial tracer 30 may utilize the partials grouping module 32 to determine whether two or more of the overlapping partials are associated with a common pitched musical event or whether they are each associated with a distinct pitched musical event. In some embodiments, the partials grouping module 32 may process one or more properties of each two or more overlapping partials to determine whether the properties present a correlation which is indicative of a common pitched musical event or not. As mentioned above, the properties of the partials may include, but are not necessarily limited to: start time, duration, pitch envelope, average pitch, salience envelope, average salience, etc. For example, if the ratio between the average pitch, or the instantaneous pitch represented by the pitch envelope is approximately integral during a substantial time duration, the two or more overlapping partials are regarded as being associated with a common pitched musical event.

In further embodiments, in case the partials grouping module 32 indicates that two or more overlapping partials are associated with a common pitched musical event, the partial tracker 30 may be adapted to integrate the properties of the partials to provide a single set of properties for a common pitched musical event. The integration of the properties may be carried in various ways which would be apparent to those of ordinary skill in the art.

Having described the process of identifying a partial and extracting properties of an identified partial, there is now provided a description of a preprocessor module 25 which may be implemented as part of the system 100, according to some embodiments of the invention. In some embodiments, a preprocessor module 25 receives the multi-channel music input, typically through the music content interface 15. Typically the music input includes two channels. The preprocessor module 25 is adapted to implement a center cut algorithm in order to extract from the multi-channel output (e.g., stereo) the central components of the incoming signal and separate them from the side signals. The center cut algorithm is a separation algorithm that works in the frequency domain. By analyzing the phase of audio components of the same frequency on the left and right channels, the algorithm attempts to determine the approximate center channel. The center channel is then subtracted from the original input to produce the side channels.

The preprocessor module 25 and the center cut algorithm which it implements may reduce the number of musical sources per channel, since some musical sources may be typically panned partially or fully to the left and to the right, and by separating the center channel from the sides a certain degree of separation may be achieved.

Having described in detail the system 100 for generating pitched musical events corresponding to the musical content, there is now provided a brief description of a music based video game 50 which may receive as input pitched musical events from the system 100. As mentioned above, the music-based video game 50 is a game in which a dominant gameplay scheme is associated with and/or oriented around musical event(s), or a property of a musical event(s) and the musical event(s) are derived from a certain musical content piece. The gameplay scheme provides a specification for a series of player's interactions which generally correspond to the underlying musical content. In some embodiments, the pitched musical events provided by the system 100 may be used by the music-based video game 50 in conjunction with other types of musical events. The extraction of such other types of musical events is outside the scope of the present invention.

The implementation and the internal structure of various types of music based video games would be apparent to those versed in the art. The description below relates to a highly generalized architecture of one possible example of a music based video game, and it is not intended to limit the scope of the present invention. According to some embodiments, the pitched musical events (PME) may be received at the music based video game 50 from the system 100 for generating pitched musical events. The music based video game 50 may feed the PME to the gameplay engine 51. The gameplay engine 51 may implement the game simulation loop (predefined game events logic) in order to manipulate the gameplay events. According to some embodiments, certain gameplay events may be generated based on the PME.

As part of some embodiments, the game engine 51 may provide instructions to the graphic rendering module 52 to render graphic object which correspond the gameplay events that are based on the respective PMEs. As part of further embodiments, the graphic rendering module 52 may represent each gameplay event, including gameplay events that are based on PMEs, as rendered graphics objects of one or more of the following types:

Game entities—“notes” according to significant musical events.

Game Arena—pitch changes can manipulate the 2D or 3D Space while playing corresponding the music.

Environment—Pitch changes can control background effect of environment condition (light level).

As part of some embodiments, the game engine 51 may provide instructions to the audio engine 53 to incorporate into the game's audio stream audio cues (such as audience feedback while playing solo or error messages) which are associated with gameplay events that are based on respective PMEs. As part of further embodiments, at least one component of the game's audio stream may be associated with the musical content from whence the PMEs were extracted.

As part of some embodiments, the game engine 51 may provide instructions to the output interface 54 to generate a certain output event which is associated gameplay events that are based on respective PMEs. For example, the game engine 51 may provide instructions to the output interface 54 to generate a vibration through the game controller in connection with a certain gameplay event that is based on a respective PME.

The input interface 55 may receive indications with respect to player(s) interaction, including in connection with gameplay events that are based on respective PMEs. The feedback from the input interface 55 may be processed by the game engine 51 and may influence subsequent gameplay events. The feedback from the input interface 55 may also be processed by the scoring module 56, which may implement a set of predefined rules in order to translate the player(s) input during a game session to numerical (score) or objects representation (trophies).

A game database 57 may possibly also be used to record an account of the game's assets (graphics, audio, effects) and garners' logs (scores, game history profile, achievements, social graph).

The music based video game may be implemented in hardware, in software and in any combination thereof. For example the music-based video game may be implemented as a game console with dedicated hardware components, general purpose hardware modules and software embodied as a computer-readable medium and instructions to be executed by a processing unit. As part of other embodiments of the invention, the music-based video game may be otherwise implemented on other computerized platforms including, but not limited to: a server, as a web application, a PC as a local application, as a distributed application partially implemented as an agent application running on a client side mobile platform and partially implemented on a server in communication with the client side agent. It would be apparent to those versed in the art that the music-based video game may be implemented in various ways, and the present invention is not limited to any particular implementation.

According to some embodiments each of the musical content source 40, the system 100 for generating pitched musical events corresponding to the musical content and the music based video game 50, may reside on a common hardware platform with one or more of the other components or each of the musical content source 40, the system 100 for generating pitched musical events corresponding to the musical content and the music based video game 50 may be separately and remotely implemented relative to the other components and the components may be connected to one or more of the other components via a wired or via a wireless connection.

While certain features of the invention have been illustrated and described herein, many modifications, substitutions, changes, and equivalents will occur to those skilled in the art. It is therefore to be understood that the appended claims are intended to cover all such modifications and changes as fall within the true scope of the invention.

1. A method of suggesting pitched musical events corresponding to provided digital musical content, comprising:
obtaining a frequency domain representation of the digital musical content;
applying a pitch salience estimation over the frequency domain representation to provide a pitch salience time-frequency map; and
grouping local frequency peaks along a time axis of the pitch salience time-frequency map which are substantially continuous in terms frequency and/or salience giving rise to a partial.

2. The method according to claim 1, further comprising:
setting a start of the partial according to the start time of the first local frequency peak in the group; and
determining a duration of the partial according to time duration from the first local frequency peak to the last local frequency peak in the group

3. System for generating pitched musical events corresponding to musical content, comprising:
a time-frequency transformation module adapted to provide a frequency domain representation of the musical content;
a pitch salience estimator adapted to apply a pitch salience estimation over the frequency domain representation to provide a pitch salience time-frequency map; and
a partial tracker adapted to group local frequency peaks along a time axis of the pitch salience time-frequency map which are substantially continuous in terms frequency and/or salience giving rise to a partial.
